(19) United States
(12) Patent Application Publication
(10) Pub. No.: US 2003/0183574 A1
(43) Pub. Date: Oct. 2, 2003

(54) Method and means for purification of water by reverse osmosis

(76) Inventors: Per-Ake Claesson, Norruhammar (SE); Zsolt Hegmegi, Norruhammar (SE); Tibor Nemeth, Norruhammar (SE); Stefan Valfridsson, Norruhammar (SE)

Correspondence Address: PEARNE & GORDON LLP, 526 SUPERIOR AVENUE EAST, SUITE 1200, CLEVELAND, OH, 44114-1484, US

(21) Appl. No.: 10/381,013

(22) PCT Filed: Sep. 25, 2001
(86) PCT No.: PCT/SE01/02050

(30) Foreign Application Priority Data
Sep. 26, 2000 (SE) 00034520

(51) Int. Cl. B01D 61/02; B01D 65/02

(52) U.S. Cl. 210/636; 210/652; 210/321.69

(57) ABSTRACT

The present invention is for method and means for purification of water using reversed osmosis. Water is forced through a membrane element (10) under pressure, which is obtained by a high pressure pump (2), where the water which is supplied to the element (10) is both from the outside supplied, unpurified water and internally circulated water that has passed by the element at its inlet side. The high pressure pump operates intermittently and the quantity of water that is circulated internally is at least as large as the quantity of water that is supplied from the outside. After that the pressure has been reduced there is a time delayed flush cleaning of the element (10) by flushing with water that is supplied from outside.

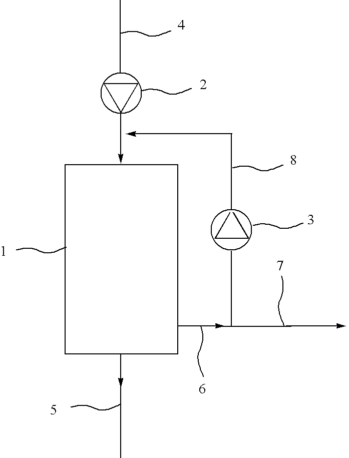

The present invention is for method and device for purification of water using reversed osmosis at high flow. The device is intended to be used by individual households and the like users where the consumption of water is intermittent and amounts to only small quantities per time unit.

It is an object of the present invention to advise a method to purify water by reversed osmosis at intermittent operation where clogging of the element by impurities and growth is avoided. It is also an object of the invention to avoid breaks in the operation for cleaning. It is a further object of the invention that cleaning may be made without the use of special equipment or special devices. It is also an object of the invention to advise a method to arrange the element so that damages due to wear may be avoided.

The device according to the invention comprises a filter including an osmotic element of a kind that is known in the art. The element, which may comprise several sheets of membranes, is wound on to a hollow, centrally positioned cylinder the wall of which has a number of holes through which purified water is diverted. In order to prevent the membrane layer from getting into direct contact with one another a distance member, being a corresponding number of fine mesh nets, is wound around the cylinder together with the membrane. It is preferred to use the kind that is made by extrusion of thermoplastic material. At the manufacture of these and other kinds of nets thicker section are formed at the points of crossing of the threads of the net. These sections may cause wear of the membrane and cause damages which result in less good or unsatisfactory function of the element. This risk for troubles in the operation may be avoided with the device according to the invention.

The method of purifying water with reversed osmosis according to the invention comprises forcing pressurized water through an element with osmotic membranes, which is achieved using a high pressure pump, where the water which is fed to the pump is both externally supplied, not purified water, and internally circulated water which has bypassed the element at its inlet side. The high pressure pump works intermittently and the internally circulated quantity of water as at least as large as the quantity of water which is fed in from the outside. After a reduction of the pressure in the intermittently operating device there is a time delayed flush cleaning of the element by flushing with water that is supplied from the outside. Preferably cleaning is performed after that both sides of the element have been under ambient pressure. The periods of operation at high pressure and large flow preferably last for not more than ten minutes.

The invention will below be described with reference to embodiment of the enclosed figures.

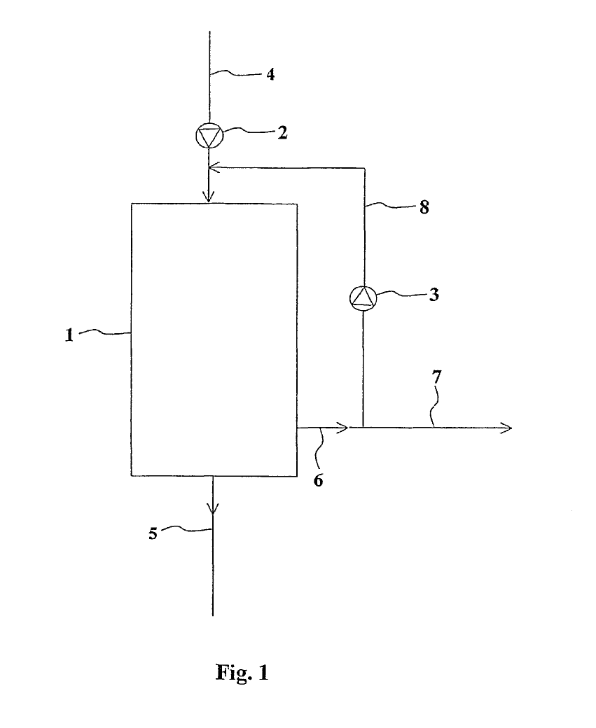

FIG. 1 schematically shows a device for purification of water using the invention.

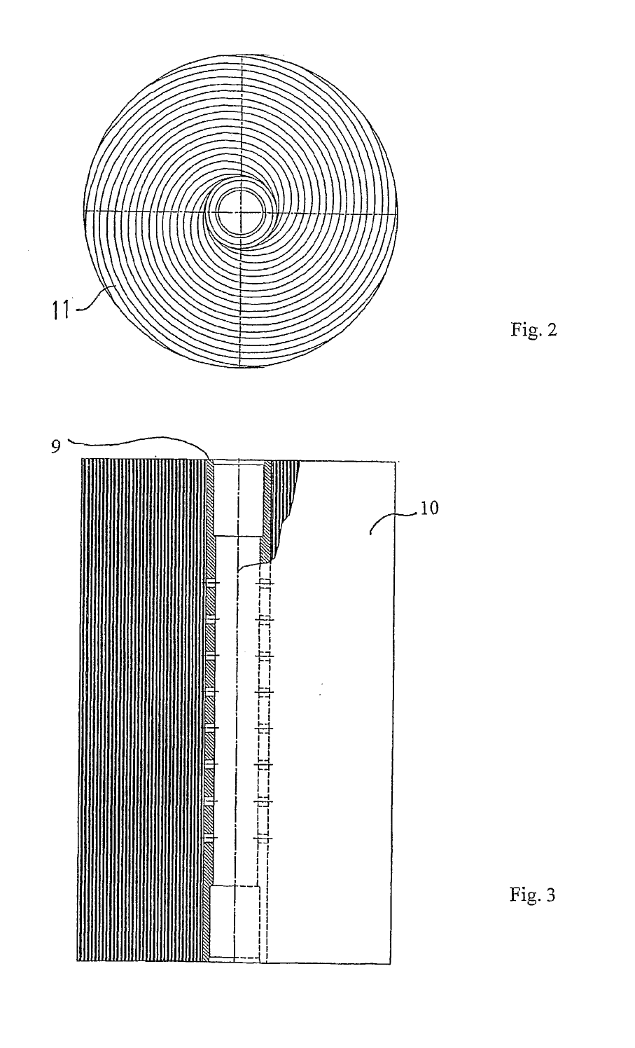

FIGS. 2 and 3 show a cross section of the filter of the device.

The device that is schematically shown in FIG. 1 comprises an element container 1. Systems of tubes of conventional designs that are arranged in or at the container are not shown in the figure. Unpurified water is supplied through an inlet tube 4 and is pumped into the element container 1 using a high pressure pump 2. The purification procedure includes that some of the water passes through the element whereby salts that are dissolved in the water mainly remain in that water which does not pass through the element. Purified water is separated and discarded through a first outlet conduit 5 while unpurified water having an increased salt content is discarded from the container through a second outlet conduit 6. The unpurified water is divided into two fractions some of which leaves the system via an outlet tube 7 and another fraction is returned to the inlet by being pump by a pump 3 through a tube 8. The pumps 2 and 3 and the tubes 6 and 8 are built with the container 1 to form one unit. These means may in a preferred embodiment be made so that both the high pressure pump and the return pump 3 have a common motor and driving shaft. The device also comprises means for supplying water to one side of the element when the high pressure pump is not operating and to supply, under timer control, inlet water by this means for flushing of the inlet side of the element. The salt content of the inlet water causes an osmotic pressure which in its turn causes a return flow through the element whereby this is flushed clean. Preferably it is arranged so that the outlet side of the element is under ambient pressure and that an outlet conduit which is connected there is permanently open without any closing means. Under operation discarding is made directly to a collecting vessel.

The element 10 that is placed in the container 1 is shown in cross section in FIGS. 2 and 3. The element is in the shape of a relatively thin sheet 11 made from a suitable membrane material which is wound around a cylindrical tube 9. The active part of the membrane is very thin and carried by a carrier layer of flexible material. A typical thickness of the layers is about 1 micron for the membrane layer and about 40 microns for the carrier layer. In the walls of the tube 9 there are a number of holes for discarding of purified water. The membrane has been wound several turns around the cylinder and in order to avoid direct contact between the separate turns of the membrane 2 distance net is inserted between the membrane surfaces. The great changes of the pressure bring with them that the membranes are exposed to wear from the distance nt. In order to reduce the risk for damages due to wear the covering layer of the net shall be directed at the convex side of the membrane which is the outer side when rolling the membrane package.

At the operation of the device according to the invention the following procedure is followed. After the start unpurified water is supplied at high pressure, when the pressure of the pump exceeds the osmotic pressure of the worked media then water will flow through the element 11 to the outlet 5. The water efficiency then is at least 50% which means that at least half of the inlet water flows through the element. In order to avoid a concentration polarisation that would cause an increased osmotic pressure an internal circulation of unpurified water is achieved through the tubes 6 and 8 by means of the pump 3. The internally circulated quantity ought to be larger than the quantity that is larger that the quantity of water which is supplied from the outside, preferably the internally circulated quantity is at least twice as large as the quantity that is added from the outside or more than four times as large as the quantity of purified water. This causes an increased speed of the water at the surface of the membrane that brings with it a reduced border layer thickness and increased turbulence, these effects will result in increased shear stresses that keep the surface of the membrane clean.

After a period of operation of up to ten minutes there follows a period of non-operation up to the next discard of water. The system then becomes pressure equalised, there are no pressure differences between the sides of the element. The greatly increased concentration at the inlet side of the element of matters that have been removed from the supplied water cause a concentration polarisation with the effect that purified water flows back through the element from the clean water side and thus forces away and lifts off the removed matters from the surface of the membrane. After a certain time, suitably some minutes, incoming unpurified water is flushed through the device and the water having an increased concentration of salts and other matter are flushed away from the element.

Further details of the design and operation of the device are apparent from the following example. The device is connected to a regular electrical connection of the kind that is allowed in wet environments. A first indicator light (LED) of a certain colour, preferably green, is then turned on and lights. The starting is affected by actuation of a tap that opens the flow of water and a second indicator light (LED) is turned on and lights. The conductivity of the outflowing water, which in this connection is a relevant indication of the quality of the water, is measured using a conductivity meter which is included in the device and when it has reached a value that is acceptable compared to the inlet water then another indicator light (LED) is lit. Prurified water is produced at a flow rate of up to three litres per minute until the process is terminated by that the flow is interrupted.

The water that is supplied to the device passes, adjacent the inlet before the high pressure pump, both through a screen cloth of a kind which is abundant in household equipment, and through a carbon filter by means of which particles are removed and the content of chlorine is reduced. The water which is let in often comes from community purification plants or similar and is then usually chlorinated. Some of the water is forced through the element unit and the purified water—the osmosis water—is diverted through the tap. At the same time reject water is diverted through a constant flow valve to a reject conduit. The system is controlled and kept constant by means of a pressure regulating valv. This pressure determines the maximum salt content of the supplied water which decides the osmotic pressure that has to be lower than the system pressure.

After that the flow has ben interrupted and the diversion of water has stopped then the device may rest in order to allow the pressure to decrease to the ambient pressure during which time the membranes of the unit are cleaned as described above and when the concentration polarisation has been equalized, flushing with inlet water takes place so that all of the water in the device is circulated.

In an applied case the inlet flow was 3.7 litres per minute and the system pressure after the high pressure pump was 10 bars. The diverted flow of purified water was 2.5 litres per minute for ten minutes after which the flow was stopped. After two minutes of standstill there was 90 seconds of flushing after which the device was ready for another cycle of operation.

1. Method for purification of water using reversed osmosis whereby water is forced through a membrane element under pressure, which is obtained by a high pressure pump (2), where the water which is supplied to the element (10) is both from the outside supplied, unpurified water and internally circulated water that has passed by the element at its inlet side characterized in that the high pressure pump operates intermittently, that the quantity of water that is circulated internally is at least as large as the quantity of water that is supplied from the outside and that after that the pressure has been reduced there is a time delayed flush cleaning of the element (10) by flushing with water that is supplied from outside.

2. Method according to claim 1 characterized in that flush cleaning takes place after that both sides of the element (10) have been at ambient pressure.

3. Method according to any of the claims 1-2 characterized in that the high pressure intervals last for not more than ten minutes.

4. Device for purification of water using reversed osmosis whereby water is forced through a membrane element under pressure, which is obtained by a high pressure pump (2), where the water which is supplied to the element (10) is both from the outside supplied, unpurified water and internally circulated water that has passed by the element at its inlet side characterized in that in comprises means to supply inlet water to one side of the element when the high pressure pump is not in operation and means to supply, under time control, inlet water through this means for flushing of the inlet side of the element.

5. Device according to claim 4 characterized in that the outlet side of the element (10) is at ambient pressure and that an outlet conduit (5) is connected there and is permanently open without closing means.
